(19) United States
(12) Patent Application Publication
(10) Pub. No.: US 2021/0103300 A1
(43) Pub. Date: Apr. 8, 2021

(54) AUXILIARY MOVING METHODS OF MOBILE PLATFORM, MOBILE DEVICES, AND MOBILE PLATFORMS

(71) Applicant: SZ DJI TECHNOLOGY CO., LTD., Shenzhen (CN)

(72) Inventors: Litian ZHANG, Shenzhen (CN); Kun LIU, Shenzhen (CN); Jie QIAN, Shenzhen (CN)

(73) Assignee: SZ DJI TECHNOLOGY CO., LTD., Shenzhen (CN)

(21) Appl. No.: 17/124,399

(22) Filed: Dec. 16, 2020

Related U.S. Application Data
(63) Continuation of application No. PCT/CN2018/096635, filed on Jul. 23, 2018.

(51) Int. Cl. G05D 1/10; G05D 1/12; G05D 1/00

(52) U.S. Cl. CPC G05D 1/106; G05D 1/0094; G05D 1/12

(57) ABSTRACT

The present disclosure provides auxiliary moving methods of a mobile platform, mobile devices, and mobile platforms. The method comprises: generating, by a mobile platform in a tracking mode, an obstacle-avoiding auxiliary instruction when the mobile platform is tracking a target object and a distance between the mobile platform and an obstacle is less than a predetermined distance; and controlling a movement trajectory of the mobile platform based on a tracking instruction and the obstacle-avoiding auxiliary instruction. The auxiliary moving methods of a mobile platform, mobile devices, and mobile platforms can be used to ensure the safe movement of the mobile platform while effectively tracking the target object, and increase the travel distance of the mobile platform.

### RELATED APPLICATIONS

The present patent document is a continuation of PCT Application Serial No. PCT/CN2018/096635, filed on Jul. 23, 2018, designating the United States and published in Chinese, content of which is herein incorporated by reference in its entirety.

### BACKGROUND

### 1. Technical Field

This application relates to the technical field of auxiliary control, and in particular to auxiliary moving methods of a mobile platform, mobile devices, and mobile platforms.

### 2. Background Information

As drones become more and more popular, more people have joined drone aerial photography. The existing mobile platform tracking strategy is to track an object with obvious characteristics as a target object. Usually during the process of tracking a certain characteristic part (such as the face) of the target object, if an obstacle is encountered, a mobile platform may directly collide with the obstacle or perform a braking operation in front of the obstacle, which cannot achieve effective obstacle avoidance, and furthermore is easy to cause lost tracking of the target object, thereby affecting the reliability of tracking.

### BRIEF SUMMARY

The present disclosure provides auxiliary moving methods of a mobile platform, mobile devices, and mobile platforms that can be used to ensure the safe movement of the mobile platform while effectively tracking the target object, and increase the travel distance of the mobile platform.

A first aspect of the present disclosure refers to an auxiliary moving method of a mobile platform. The method may include: generating, by a mobile platform in a tracking mode, an obstacle-avoiding auxiliary instruction when the mobile platform is tracking a target object and a distance between the mobile platform and an obstacle is less than a predetermined distance; and controlling a movement trajectory of the mobile platform based on a tracking instruction and the obstacle-avoiding auxiliary instruction.

A second aspect of the present disclosure refers to a mobile device. The mobile device may include: a storage medium storing program codes for performing auxiliary moving over a mobile platform; and a processor to execute the program codes to: in a tracking mode of the mobile platform where the mobile platform tracks a target object according to a tracking instruction: generating, by a mobile platform in a tracking mode, an obstacle-avoiding auxiliary instruction when the mobile platform is tracking a target object and a distance between the mobile platform and an obstacle is less than a predetermined distance; and controlling a movement trajectory of the mobile platform based on a tracking instruction and the obstacle-avoiding auxiliary instruction.

A third aspect of the present disclosure refers to a mobile platform. The mobile platform may include: a body; a power system installed on the body and configured to supply power to the mobile platform; and an above-mentioned mobile device.

According to embodiments of the present disclosure, when a mobile platform is in a tracking mode and a distance between the mobile platform and an obstacle is less than a predetermined distance, an obstacle-avoiding auxiliary instruction is generated, and the movement of the mobile platform is controlled based on the obstacle-avoiding auxiliary instruction and a tracking instruction, so that the mobile platform can ensure safe movement of the mobile platform when the mobile platform effectively tracks a target object, thereby avoiding the situation in the conventional technique that a sudden decision to stop has to be made after the prediction that the mobile platform is about to collide with the obstacle, and increasing the travel distance of the mobile platform.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show some exemplary embodiments of the present disclosure, and persons of ordinary skill in the art may still derive other drawings from these accompanying drawings without creative efforts.

FIG. 1 is a flowchart of an auxiliary moving method of a mobile platform according to some exemplary embodiments of the present disclosure;

FIG. 2 is a schematic diagram of a scenario for generating an obstacle-avoiding auxiliary instruction according to some exemplary embodiments of the present disclosure;

FIG. 3 is a schematic diagram of another scenario for generating an obstacle-avoiding auxiliary instruction according to some exemplary embodiments of the present disclosure;

FIGS. 4a-4c are side views of the movement of a mobile platform according to some exemplary embodiments of the present disclosure;

FIG. 5 is a schematic top view of a mobile platform according to some exemplary embodiments of the present disclosure;

FIG. 6 is a flowchart of a process of generating an obstacle-avoiding auxiliary instruction according to some exemplary embodiments of the present disclosure;

FIG. 7 is a schematic diagram of a process of generating a movement trajectory according to some exemplary embodiments of the present disclosure;

FIG. 8 is a schematic diagram of a velocity change of a mobile platform in any one of the left, right, up, and down directions according to some exemplary embodiments of the present disclosure;

FIG. 9 is a schematic diagram of another scenario for generating an obstacle-avoiding auxiliary instruction according to some exemplary embodiments of the present disclosure;

FIG. 10 is a flowchart of step 103 according to some exemplary embodiments of the present disclosure;

FIG. 11 is a schematic diagram of a plurality of movement trajectories according to some exemplary embodiments of the present disclosure;

FIG. 12 is a flowchart of step 103 according to some exemplary embodiments of the present disclosure; and

FIG. 13 is a structural diagram of a mobile device according to some exemplary embodiments of the present disclosure.

### DETAILED DESCRIPTION OF THE DRAWINGS

Unless otherwise defined, meanings of all technical and scientific terms used in this specification are the same as those generally understood by persons skilled in the art of the present disclosure. The terms used in this specification of the present disclosure herein are used only to describe specific embodiments, and not intended to limit the present disclosure. The term “and/or” used in this specification includes any or all possible combinations of one or more associated listed items.

The following describes in detail some implementations of the present disclosure with reference to the accompanying drawings. Under a condition that no conflict occurs, the following embodiments and features in the embodiments may be mutually combined. The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some exemplary embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some exemplary embodiments, the numerical parameters set forth in the written description and the appended claims are approximations, which may vary depending upon the desired properties sought to be obtained in a particular embodiment. In some exemplary embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

Technical solutions in embodiments of the present disclosure will be clearly described below with reference to the drawings therein. The described embodiments are merely part of the embodiments of the present disclosure rather than all of them. Based on the embodiments of the present disclosure, all the other embodiments obtained by those skilled in the art without creative work shall fall within the protection scope of the present disclosure.

It should be noted that when a component is said to be “fixed” to another component, the component may be directly provided on another component or there may be a connecting component therebetween. When a component is considered to be “connected” to another component, the component may be directly connected to another component or there may be a connecting component therebetween.

Unless otherwise defined, all the technologies and terms used in the context of the present disclosure have the same meaning as commonly understood by those skilled in the technical field of the present disclosure. The terms used in the specification of the present disclosure only serve to describe specific embodiments, rather than limit the present disclosure. The term “and/or” as used herein includes any of one or more related listed items and all the combinations thereof.

Some exemplary embodiments of the present disclosure will be described below in detail with reference to the accompanying drawings. If no conflict is caused, the following embodiments and features therein may be combined.

Some exemplary embodiments of the present disclosure provide an auxiliary moving method of a mobile platform, which may include: in a tracking mode of the mobile platform, when a distance between the mobile platform and an obstacle is less than a predetermined distance, generating an obstacle-avoiding auxiliary instruction and controlling the movement of the mobile platform based on the obstacle-avoiding auxiliary instruction and a tracking instruction, so that the mobile platform can ensure safe movement of the mobile platform while ensuring that the mobile platform effectively tracks a target object, thereby avoiding the situation in the conventional technique that a sudden decision to stop has to be made after the prediction that the mobile platform is about to collide with the obstacle, and increasing the travel distance of the mobile platform.

In some exemplary embodiments of the present disclosure, the tracking mode may refer to a process in which the mobile platform, without a user's operation, follows the target object during the movement of the target object.

In some exemplary embodiments of the present disclosure, and as one of the ordinary skilled in the art would understand, the term “instruction” may refer to an electrical signal sent from a processor and/or controlling component of the mobile platform to the propellors of the mobile platform. As a result, the propellors may generate corresponding driving forces to drive the mobile platform. That is, the instruction may directly reflect a force acting on the mobile platform. For example, the tracking instruction may reflect a force for controlling the mobile platform to follow the target object. For example, the obstacle-avoiding auxiliary instruction may reflect a force for controlling the movement of the mobile platform in an auxiliary way. Therefore, the present disclosure may use the term “instruction” to describe how the processor and/or control component to maneuver the mobile platform.

In some exemplary embodiments of the present disclosure, the tracking instruction may refer to a control instruction for controlling the mobile platform to follow the target object, wherein the control instruction may be a velocity instruction or an acceleration instruction, and the tracking instruction may be used for instructing the mobile platform to track the target object. For example, the mobile platform may obtain a current position of the mobile platform and a current position of the target object, and run a preset target tracking algorithm according to the current position of the mobile platform and the current position of the target object to obtain the tracking instruction that controls the mobile platform to follow the target object. Further, the mobile platform may filter and smooth the instruction output by the target tracking algorithm to obtain the tracking instruction.

In some exemplary embodiments of the present disclosure, there may be a plurality of ways to trigger the generating of the obstacle-avoiding auxiliary instruction.

In some exemplary embodiments, the mobile platform may store map information of the current environment. When the mobile platform detects that a distance between the current position and the obstacle is less than a predetermined distance, or predicts that the mobile platform will collide with the obstacle within a predetermined time at a current velocity, or detects that the distance between the current position and the obstacle is less than the predetermined distance and a current velocity direction in which the mobile platform points to the obstacle, or after an obstacle-avoiding auxiliary mode of the mobile platform is activated, the mobile platform may start to execute an operation of generating an obstacle-avoiding auxiliary instruction.

The map information of the current environment stored on the mobile platform may be downloaded from a server, or obtained based on detection data of a sensor on the mobile platform. The sensor may include a vision sensor (e.g., a binocular camera, a monocular camera) and/or a distance sensor (e.g., a time-of-flight (TOF) camera, a LiDAR). For example, in an exemplary embodiment where the mobile platform is a drone, the map information may be obtained by the drone based on the detection data of the sensor in the same flight or in different flights, where a flight between adjacent take-off and landing by the drone is called one flight.

Activation of the obstacle-avoiding auxiliary mode on the mobile platform may be triggered based on an instruction input by the user. For example, the user's operation interface configured to control the mobile platform may be provided with a physical button or a virtual button, or the operation interface may be provided with an obstacle-avoiding auxiliary mode option. When it is detected that a user is operating the physical button or the virtual button or the obstacle-avoiding auxiliary mode option, it may be determined to enter the obstacle-avoiding auxiliary mode of the mobile platform.

In some exemplary embodiments, the obstacle-avoiding auxiliary mode on the mobile platform may be automatically enabled by default when it is detected that the distance between the current position and the obstacle is less than the predetermined distance, or it is predicted that the mobile terminal will collide with the obstacle within a predetermined time at the current velocity, or it is detected that the distance between the current position and the obstacle is less than the predetermined distance and the current velocity direction in which the mobile platform is facing towards the obstacle. In some exemplary embodiments, the user may choose to disable the function of automatically activating the obstacle-avoiding auxiliary mode by default.

In some exemplary embodiments, an obstacle-avoiding auxiliary instruction may be continuously generated during the movement of the mobile platform. Under certain conditions, the movement of the mobile platform may be controlled based on the obstacle-avoiding auxiliary instruction.

In some exemplary embodiments of the present disclosure, there may be a plurality of methods for generating an obstacle-avoiding auxiliary instruction.

In some exemplary embodiments, the mobile platform may determine a target direction of the mobile platform based on the tracking instruction, generate at least one predicted trajectory that bypasses the obstacle and can move toward the target direction, determine a target predicted trajectory from the at least one predicted trajectory, generate the obstacle-avoiding auxiliary instruction that enables the mobile platform to move along the target predicted trajectory based on the target predicted trajectory and the tracking instruction, and control movement of the mobile platform based on the obstacle-avoiding auxiliary instruction and the tracking instruction.

In some exemplary embodiments, the target direction may be the same as the velocity direction of the mobile platform corresponding to the tracking instruction. In some exemplary embodiments, the mobile platform may predict the target direction of the mobile platform within a certain time window in the future based on the tracking instruction. In some exemplary embodiments, the target direction may be the same as the predicted velocity direction of the mobile platform. It is understandable that when the tracking instruction changes, the obstacle-avoiding auxiliary instruction may change accordingly.

It should be noted that the velocity direction of the mobile platform corresponding to the instructions mentioned in the specification may refer to the direction of movement of the mobile platform based on the instructions controlling movement when the mobile platform is stationary.

In some exemplary embodiments, the mobile platform may generate a variety of obstacle-avoiding auxiliary instructions based on the tracking instruction according to specific rules. The mobile platform may predict separately movement trajectories of the mobile platform under the action of different instructions or combinations of instructions in a certain time window in the future based on a current moving state and at least one of the instructions selected from a tracking instruction, an obstacle-avoiding auxiliary instruction currently used to control the movement of the mobile platform, and a plurality of candidate obstacle-avoiding auxiliary instructions generated for a certain time window in future. The predicted plurality of movement trajectories serve as candidate movement trajectories, a target movement trajectory is determined from the plurality of candidate movement trajectories according to predetermined conditions, and movement of the mobile platform is controlled within a certain time window in the future according to an obstacle-avoiding auxiliary instruction corresponding to the target movement trajectory.

It should be noted that in some scenarios, e.g., in a scenario where the mobile platform does not collide with an obstacle within a certain period of time based on the tracking instruction, there may be no obstacle-avoiding auxiliary instruction in the instructions corresponding to the target movement trajectory. Then in the time window, the movement of the mobile platform is controlled only based on the tracking instruction, and the obstacle-avoiding auxiliary instruction generated is not used to control the mobile platform.

There may be many methods for the mobile platform to predict the tracking instruction within a certain time window in the future. For example, the mobile platform regards the tracking instruction as a predicted tracking instruction within a certain time window in the future. Again, for example, the mobile platform may predict the movement trajectory of the target object in a certain time window in the future, and then predict the tracking instruction in a certain time window in the future based on the tracking instruction of the mobile platform and the predicted movement trajectory of the target object in a certain time window in future.

There may be a plurality of methods for the mobile platform to generate candidate movement trajectories. In some exemplary embodiments, the mobile platform may predict to obtain at least one of the following movement trajectories according to the current moving state.

In the first possible implementation manner, the movement trajectory of the mobile platform may include:

1. in a certain time window in the future, a movement trajectory of the mobile platform based on control of a tracking instruction;

2. in a certain time window in the future, a movement trajectory of the mobile platform based on control of an obstacle-avoiding auxiliary instruction currently used to control the movement of the mobile platform and a tracking instruction; and

3. in a certain time window in the future, a movement trajectory of the mobile platform based on control of each of the plurality of candidate obstacle-avoiding auxiliary instructions generated and a tracking instruction.

In the second possible implementation manner, the movement trajectory of the mobile platform may include:

1. in a certain time window in the future, a movement trajectory of the mobile platform based on control of a tracking instruction predicted in a certain time window in the future;

2. in a certain time window in the future, a movement trajectory of the mobile platform based on control of an obstacle-avoiding auxiliary instruction currently used to control the movement of the mobile platform and a tracking instruction predicted in a certain time window in future; and

3. in a certain time window in the future, a movement trajectory of the mobile platform based on control of each of the plurality of candidate obstacle-avoiding auxiliary instructions generated and a control instruction input by the user predicted in a certain time window in future.

At least one of the movement trajectories may be obtained as a candidate movement trajectory. For the prediction principle in the second possible implementation manner, please refer to the latter part of the specification.

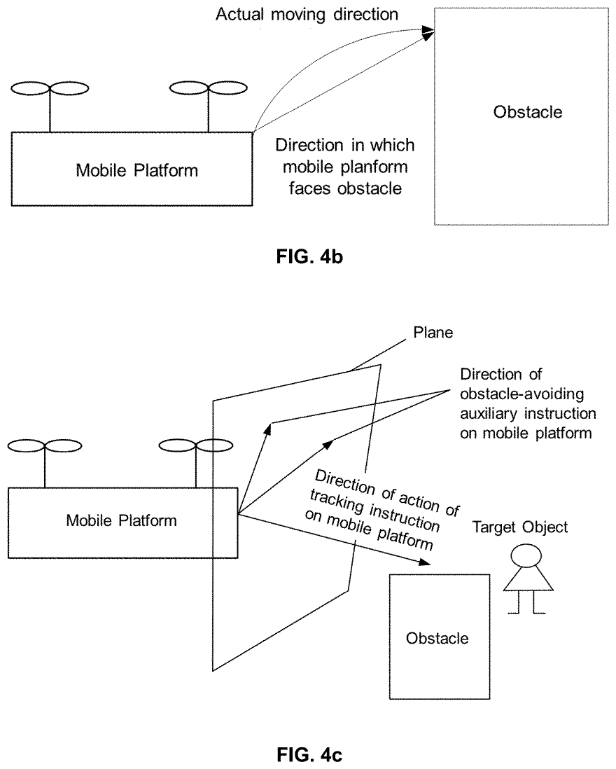

In some exemplary embodiments, regardless of the triggering method of an obstacle-avoiding auxiliary instruction, the mobile platform may generate the obstacle-avoiding auxiliary instruction when the distance between the mobile platform and the obstacle is less than the predetermined distance. Moreover, in the adopted obstacle-avoiding auxiliary instruction, when the obstacle-avoiding auxiliary instruction is used to control the movement of the mobile platform, the obstacle-avoiding auxiliary instruction can increase a velocity component of the mobile platform along a first direction, wherein the first direction may refer to one of the directions perpendicular to a direction in which the mobile platform points to the obstacle. The direction in which the mobile platform points to the obstacle may be a direction of the shortest connecting line between the mobile platform and the obstacle, or a direction of a connecting line between a certain point on the mobile platform and a certain point of the obstacle, which is not limited herein. For example, FIG. 4a and FIG. 4b are side views of the movement of a mobile platform according to some exemplary embodiments of the present disclosure, as shown in FIG. 4a and FIG. 4b, the direction of the mobile platform facing towards the obstacle may be defined as the direction of movement of the mobile platform facing towards the obstacle in the horizontal direction, or the current moving direction of the mobile platform towards the obstacle, which, however, is not limited to defining manners shown in FIGS. 4a and 4b.

The obstacle-avoiding auxiliary instruction may increase the velocity component of the mobile platform along the first direction, which means that the velocity direction of the mobile platform corresponding to the obstacle-avoiding auxiliary instruction is the first direction, or that when the mobile platform moves under the control of the tracking instruction, after the obstacle-avoiding auxiliary instruction is added, the component of the velocity of the mobile platform in the first direction may increase. After control of the obstacle-avoiding auxiliary instruction is added, the mobile platform will change the original movement trajectory (that is, the movement trajectory of the mobile platform under the control of the tracking instruction only). The second case is taken as an example.

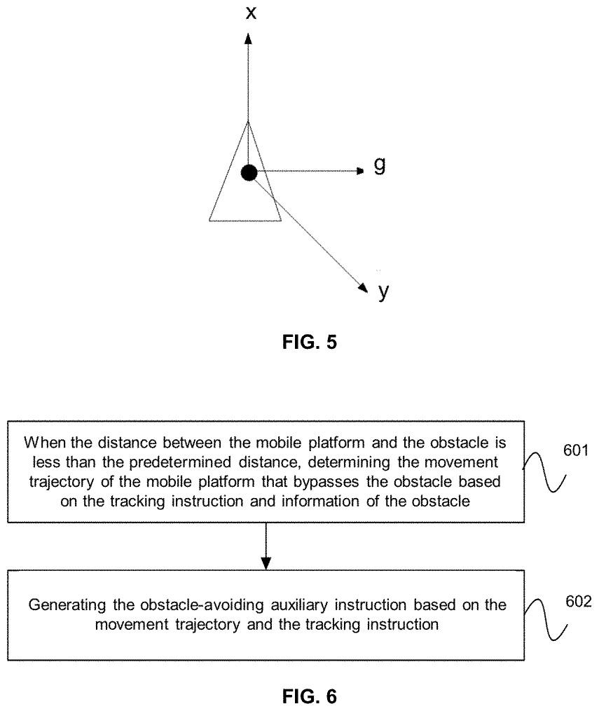

For example, FIG. 5 is a schematic top view of a mobile platform according to some exemplary embodiments of the present disclosure. As shown in FIG. 5, direction x is the direction in which the mobile platform points to the obstacle, and direction y is the velocity direction applied by the obstacle-avoiding auxiliary instruction. There may be an angle between direction y and direction x, and velocity in direction y may be decomposed to obtain a velocity component perpendicular to direction x, i.e., the velocity component in direction g in FIG. 5, and the mobile platform may change the current movement trajectory under the action of the velocity component in direction g. In these embodiments, taking the situation where the angle between the velocity in direction y and the velocity in direction x is greater than 90 degrees, for example, the velocity in direction y may be decomposed into a velocity component perpendicular to direction x and a velocity component opposite to direction x. The velocity component perpendicular to direction x may change the movement trajectory of the mobile platform, and the velocity component opposite to direction x may reduce or offset the velocity component of the mobile platform in a direction facing towards the obstacle and caused by the tracking instruction (i.e., a velocity component in direction x), to achieve the purpose of avoiding obstacles or allowing the mobile platform to further move for a period of time before a collision. FIG. 5 only shows examples for illustrations rather than a unique limitation on the present disclosure.

In some exemplary embodiments, the direction in which the obstacle-avoiding auxiliary instruction acts on the mobile platform may be perpendicular to the direction in which the tracking instruction acts on the mobile platform. Taking FIG. 4c being a side view of the movement of a mobile platform according to some exemplary embodiments of the present disclosure, for example, the tracking instruction may be used for instructing the mobile platform to track the target object, the direction in which the tracking instruction acts on the mobile platform may be the direction as shown in FIG. 4c, and the direction in which the obstacle-avoiding auxiliary instruction acts on the mobile platform may be perpendicular to the direction of the tracking instruction on the mobile platform. Further, if a plurality of obstacle-avoiding auxiliary instructions are generated, the direction in which the obstacle-avoiding auxiliary instructions act on the mobile platform may be distributed in a plane perpendicular to the direction in which the tracking instruction acts on the mobile platform.

It should be noted that the direction in which the obstacle-avoiding auxiliary instruction acts on the mobile platform may be perpendicular to the direction in which the tracking instruction acts on the mobile platform, or it may form a certain angle with the direction in which the tracking instruction acts on the mobile platform. The angle may be 30 degrees or 100 degrees, etc., and is not specifically limited by the embodiments of the present disclosure.

In some exemplary embodiments, velocity of the mobile platform caused by the obstacle-avoiding auxiliary instruction may be proportional to velocity of the mobile platform caused by the tracking instruction. That is, the greater the velocity of the mobile platform caused by the tracking instruction is, the greater the velocity of the mobile platform caused by the obstacle-avoiding auxiliary instruction is.

In some exemplary embodiments, during the movement of the mobile platform, the area within the angle of view (FOV) of the vision sensor, excluding the obstacle area, may be set as an open area, and the area outside the FOV of the vision sensor may be set as an unknown area. The mobile platform may determine the open area and the unknown area in the map of the current environment, as well as the open area determined at the previous moment. The mobile platform may update a region in the unknown area of the current environment map that overlaps with the open area at the previous moment as the open area, and thereby the mobile platform can move in the updated open area, which can improve the safety of the mobile platform and realize effective obstacle-avoidance.

The auxiliary moving method in embodiments of the present disclosure will be described below with reference to examples.

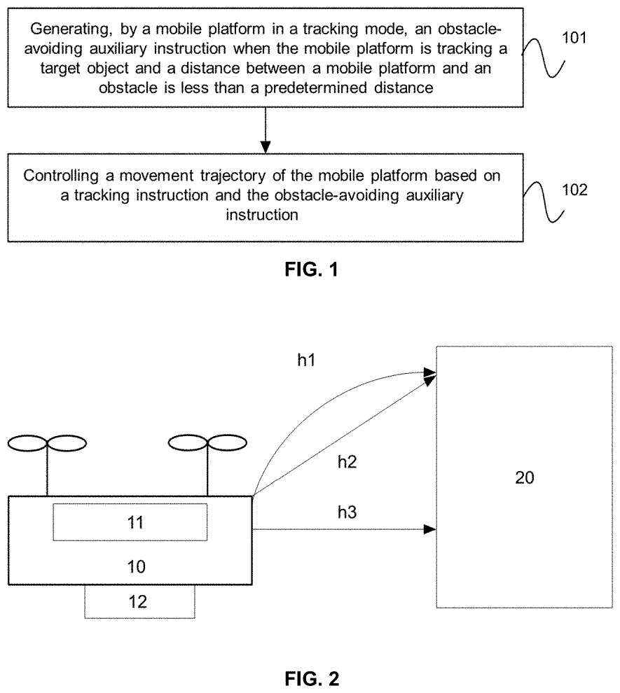

Embodiments of the present disclosure provide an auxiliary moving method. FIG. 1 is a flowchart of an auxiliary moving method according to some exemplary embodiments of the present disclosure. As shown in FIG. 1, the method may include the following steps.

Step 101. Generating, by a mobile platform in a tracking mode, an obstacle-avoiding auxiliary instruction when the mobile platform is tracking a target object and a distance between the mobile platform and an obstacle is less than a predetermined distance.

The mobile platform involved in these embodiments may be a device that can move by relying on its own power system. The mobile platform may be a device with a certain processing capability such as a drone or a car.

FIG. 2 is a schematic diagram of a scenario for generating an obstacle-avoiding auxiliary instruction according to some exemplary embodiments of the present disclosure. FIG. 2 shows a mobile platform 10 and an obstacle 20, wherein the mobile platform 10 may include a processor 11 and a detection device 12, and when the detection device 12 detects that a distance between the mobile platform 10 and the obstacle 20 is less than a predetermined distance, the processor 11 may be triggered to generate an obstacle-avoiding auxiliary instruction. For example, the distance between the mobile platform 10 and the obstacle 20 may be a moving distance h1 before the mobile platform 10 collides with the obstacle 20, or a linear distance h2 between the mobile platform 10 and a collision point of the mobile platform 10 on the obstacle 20, or a vertical distance h3 between the mobile platform 10 and the obstacle 20 in the horizontal direction. When the distance between the mobile platform 10 and the obstacle 20 is less than the predetermined distance, one or more obstacle-avoiding auxiliary instructions may be generated.

Further, for the generating of the obstacle-avoiding auxiliary instruction, a processing method of the processor 11 may include the following two types.

In a possible processing method, the processor 11 may determine whether to generate an obstacle-avoiding auxiliary instruction according to a tracking instruction. For example, upon determining that the tracking instruction will cause a risk of collision between the mobile platform 10 and the obstacle 20, the processor 11 may generate an obstacle-avoiding auxiliary instruction, to change a movement trajectory of the mobile platform 10 by the obstacle-avoiding auxiliary instruction. If it is determined that the tracking instruction will not cause a collision, no obstacle-avoiding auxiliary instruction is generated.

In the other possible processing method, when the detection device 12 detects that the distance between the mobile platform 10 and the obstacle 20 is less than the predetermined distance, the processor 11 may directly generate an obstacle-avoiding auxiliary instruction without detecting whether the tracking instruction will cause a collision or not.

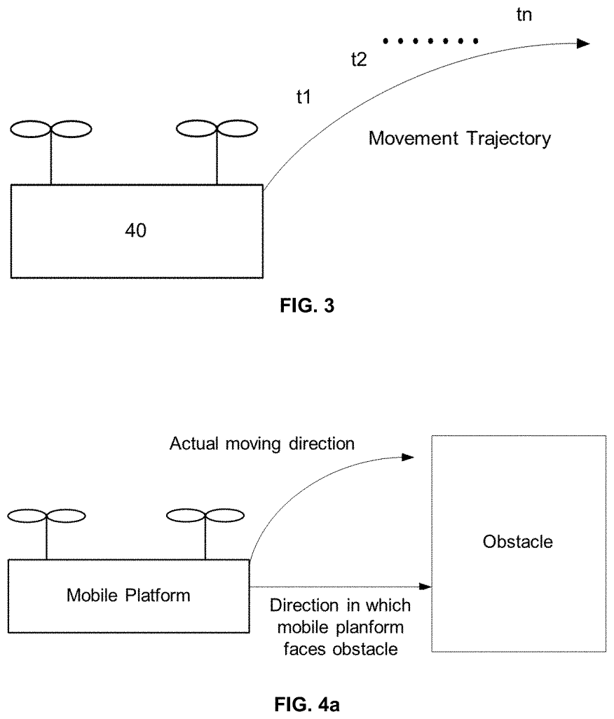

FIG. 2 is only one scenario for generating an obstacle-avoiding auxiliary instruction according to some exemplary embodiments of the present disclosure rather than all the scenarios. In fact, in other possible embodiments, an obstacle-avoiding auxiliary instruction may also be generated in other scenarios. For example, FIG. 3 is a schematic diagram of another scenario for generating an obstacle-avoiding auxiliary instruction according to some exemplary embodiments of the present disclosure. In this scenario, the mobile platform 40 may generate obstacle-avoiding auxiliary instructions at times t1, t2 . . . tn, wherein adjacent times in t1, t2 . . . tn may be equally spaced or non-equally spaced. That is, the setting for t1, t2 . . . tn may be arbitrary.

Step 102. Controlling a movement trajectory of the mobile platform based on a tracking instruction and the obstacle-avoiding auxiliary instruction.

In these embodiments, controlling a movement trajectory of the mobile platform based on a tracking instruction and the obstacle-avoiding auxiliary instruction may include: taking the tracking instruction and the obstacle-avoiding auxiliary instruction as input into a preset model, predicting by a preset model to obtain movement trajectories of the mobile platform, and further selecting a movement trajectory from the obtained movement trajectories to enable the mobile platform to move along this movement trajectory.

An example will be used to illustrate how to select a movement trajectory from the movement trajectories obtained to control the movement of the mobile platform.

For example, when an obstacle-avoiding auxiliary instruction (hereinafter referred to as a current obstacle-avoiding auxiliary instruction) is used in the current movement control of the mobile platform, screening may be performed on the one or more movement trajectories obtained by prediction to obtain a movement trajectory having the same trajectory direction as the trajectory direction of the movement trajectory (hereinafter referred to as a current movement trajectory) obtained under the action of the current obstacle-avoiding auxiliary instruction. For example, if the movement trajectory obtained under the action of the current obstacle-avoiding auxiliary instruction is on an upper side of the body, screening may be performed on the one or more movement trajectories obtained by prediction to obtain a movement trajectory positioned on the upper side of the body, which, however, is certainly only an example rather than a unique limitation. Further, the screened movement trajectories may be screened to obtain movement trajectories having movable distances greater than a movable distance of the current movement trajectory of the mobile platform by more than a preset distance (e.g., 2 m) as candidate movement trajectories. The movable distance may be a length of a target moving trajectory between the current position of the mobile platform and a point where the mobile platform is closest to collide with the obstacle. If the mobile platform is navigating along the current moving trajectory, then the target moving trajectory may be the current moving trajectory. If the mobile platform selects to navigate along a moving trajectory from a plurality of candidate/predicted moving trajectory, then the target moving trajectory may be the selected moving trajectory. For example, if an obstacle is on the current moving trajectory, the movable distance may be the distance that the mobile platform can move along the current moving trajectory before the occurrence of a collision.

When an obstacle-avoiding auxiliary instruction is not used in the current movement control of the mobile platform, a screening may be performed directly on the one or more movement trajectories obtained by prediction to obtain movement trajectories having movable distances greater than the movable distance of the current movement trajectory of the mobile platform by more than a preset distance as candidate movement trajectories.

Further, after obtaining the candidate movement trajectories, firstly a screening may be performed on the candidate movement trajectories to obtain a movement trajectory with the longest movable distance, as well as the movement trajectories having movable distances less than 1.5 m shorter than the longest movable distance. Then from the movement trajectories screened, the movement trajectory that consumes the minimum energy may be determined as an optimum candidate movement trajectory. When no movement trajectory meets the above conditions, it is determined that there is no optimum candidate movement trajectory.

When an obstacle-avoiding auxiliary instruction is used in the current movement control of the mobile platform, if the optimum candidate movement trajectory does not exist and the movable distance of the movement trajectory of the mobile platform without the action of the obstacle-avoiding auxiliary instruction is greater than the movable distance of the movement trajectory of the mobile platform under the action of the current obstacle-avoiding auxiliary instruction by more than a preset distance, the mobile platform may be controlled to move along the movement trajectory without the action of the obstacle-avoiding auxiliary instruction; otherwise, the mobile platform will still move along the current movement trajectory. If the optimum candidate movement trajectory exists and the movable distance of the movement trajectory of the mobile platform without the action of the obstacle-avoiding auxiliary instruction is greater than the movable distance of the optimum candidate movement trajectory, then the mobile platform may be controlled to move along the movement trajectory without the action of the obstacle-avoiding auxiliary instruction; otherwise, the mobile platform may be controlled to move along the optimum candidate movement trajectory.

When an obstacle-avoiding auxiliary instruction is not used in the current movement control of the mobile platform, if the optimum candidate movement trajectory does not exist, or if the optimum candidate movement trajectory exists but the movable distance of the current movement trajectory is greater than the movable distance of the optimum candidate movement trajectory, the mobile platform may be controlled to move along the current movement trajectory. If the optimum candidate movement trajectory exists and the movable distance of the current movement trajectory is shorter than the movable distance of the optimum candidate movement trajectory, the mobile platform may be controlled to move along the optimum candidate movement trajectory.

Those skilled in the art should understand that the above examples merely serve to be illustrative for clarity rather than a unique limitation on the present disclosure.

In some exemplary embodiments, in the tracking mode, the obstacle-avoiding auxiliary instruction is generated when the distance from the obstacle is less than the predetermined distance, and the movement trajectory of the mobile platform may be controlled based on the tracking instruction and the obstacle-avoiding auxiliary instruction. In this way, active obstacle-avoidance by the mobile platform may be further achieved in the tracking mode, thereby enabling the mobile platform to avoid obstacles under the combined action of the tracking instruction and the obstacle-avoiding auxiliary instruction, or to move for a longer period of time when the obstacles cannot be avoided, rather than perform a braking operation immediately after encountering obstacles, which improves the safety of the mobile platform as well as user experience.

The exemplary embodiments in FIG. 1 will be further optimized and expanded by means of the following exemplary embodiments.

FIG. 6 is a flowchart of a process of generating an obstacle-avoiding auxiliary instruction according to some exemplary embodiments of the present disclosure. As shown in FIG. 6, based on the above embodiments, the process of generating an obstacle-avoiding auxiliary instruction may include the following steps.

Step 601. When the distance between the mobile platform and the obstacle is less than the predetermined distance, determining the movement trajectory of the mobile platform that bypasses the obstacle based on the tracking instruction and information of the obstacle.

Information on the obstacle involved in some exemplary embodiments may include but are not limited to, location, size, shape, and the like of the obstacle. Information of the obstacle may be obtained from a pre-stored map, or obtained by calculation based on a preset image detection algorithm by taking an image of the obstacle. For example, firstly, an edge of the image of the obstacle may be obtained by detection by an edge detection algorithm, and further, a coordinate of a point outside the image of the obstacle may be determined based on a coordinate of a point on the edge of the image of the obstacle, and based on the coordinate of the point outside the image of the obstacle and the current position of the mobile platform, a movement trajectory that can bypass the obstacle may be obtained. Similarly, a plurality of movement trajectories that can bypass the obstacle may be obtained. Please note, these are only examples for illustrative purposes rather than a unique limitation on the present disclosure.

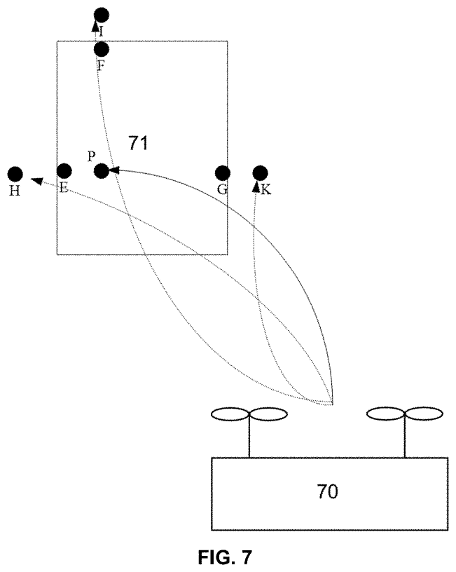

FIG. 7 is a schematic diagram of a process of generating a movement trajectory according to some exemplary embodiments of the present disclosure. As shown in FIG. 7, it is assumed that a mobile platform 70 will collide with an obstacle 71 at point P under the action of a tracking instruction. E, F, and G may be points positioned on the edge of the obstacle determined based on point P, wherein point E may be positioned on the left side of point P, point F may be positioned on the upper side of point P, and point G may be positioned on the right side of point P. Then based on points E, F and G, one or more points positioned outside the obstacle 71 may be determined. Assuming that point position H is determined based on point E, point position I is determined based on point F, and point position K is determined based on point G, then three movement trajectories that can bypass the obstacle 71 may be determined based on point positions H, I and K and the current position of the mobile platform 71. Please note, these examples merely serve for illustrative purposes rather than a unique limitation on the present disclosure.

Step 602. Generating the obstacle-avoiding auxiliary instruction based on the movement trajectory and the tracking instruction.

In some exemplary embodiments, generating the obstacle-avoiding auxiliary instruction based on the movement trajectory and the tracking instruction may include the following manners.

In a possible manner, after one or more movement trajectories that can bypass the obstacle are obtained, the movement trajectories and/or the current movement trajectory of the mobile platform may be displayed, for example, on a screen or displayer of a remote controller of the mobile platform, and an optional operation on the movement trajectories may be provided on a display interface. After the user selects a target movement trajectory, an obstacle-avoiding auxiliary instruction that needs to be added may be determined to obtain the target movement trajectory according to the tracking instruction. For example, the tracking instruction may be used to control the mobile platform to move in a direction that is 50 degrees with respect to the southeast of the current movement direction, and the target movement trajectory is moving in a direction that is 30 degrees with respect to the southeast of the current direction of movement, an obstacle-avoiding auxiliary instruction may be determined so that the mobile platform will change from the direction that is 50 degrees with respect to the southeast of the current movement direction to the direction that is 30 degrees with respect to the southeast of the current movement direction. One of ordinary skill in the art would understand that these examples merely serve for illustrative purposes rather than a unique limitation on the present disclosure.

In another possible manner, for each of the movement trajectories that can bypass the obstacle, an obstacle-avoiding auxiliary instruction that needs to be added to obtain each of the movement trajectories may be determined according to the tracking instruction. The process of generating an obstacle-avoiding auxiliary instruction may be similar to the previous one, and will not be discussed herein.

One of ordinary skill in the art would understand that the embodiments in FIG. 6 are merely achievable solutions for generating an obstacle-avoiding auxiliary instruction rather than a unique limitation on the process of generating an obstacle-avoiding auxiliary instruction. In fact, in actual scenarios, one or more obstacle-avoiding auxiliary instructions may be generated directly from the tracking instruction.

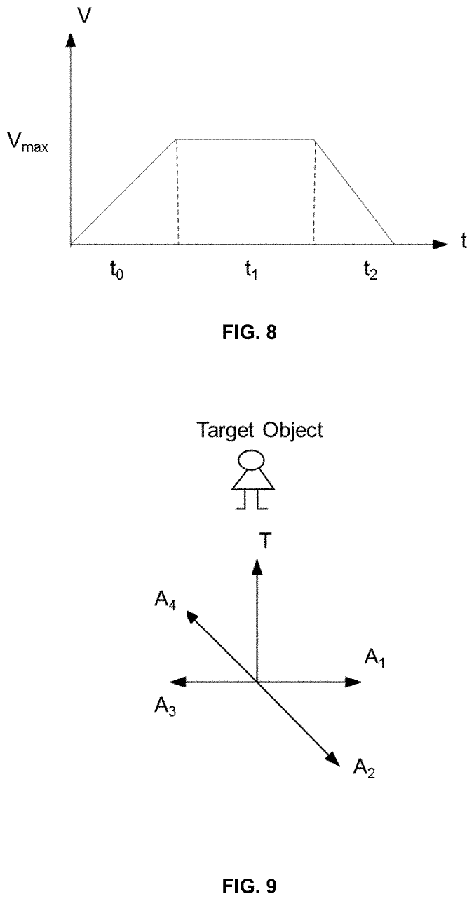

Hereinafter, embodiments will be taken for example. After determining the movement direction corresponding to the tracking instruction, based on this direction, the acting direction of the obstacle-avoiding auxiliary instruction may be divided into four directions, which are the left, right, up, and down directions of the vehicle body. In each of the directions, the obstacle-avoiding auxiliary instruction may be a velocity instruction along that direction. For example, FIG. 8 is a schematic diagram of a velocity change of a mobile platform in any one of the left, right, up, and down directions according to some exemplary embodiments of the present disclosure. As shown in FIG. 8, the velocity of the mobile platform in the direction shown in FIG. 8 increases from zero to velocity Vmax within the time length of t0 under the action of the obstacle-avoiding auxiliary instruction. velocity Vmax remains unchanged within the time length of t1, and velocity Vmax is reduced to zero again within the time length of t2. A group of Vmax, t0, t1, and t2 may correspond to one obstacle-avoiding auxiliary instruction. By changing the value of any one or more of Vmax, t0, t1, and t2, a plurality of obstacle-avoiding auxiliary instructions corresponding to the direction may be obtained to further obtain a plurality of movement trajectories in that direction. The process of generating an obstacle-avoiding auxiliary instruction in other directions may be similar, and will not be discussed herein.

Please note, those skilled in the art should understand that the direction of action of the obstacle-avoiding auxiliary instruction may not be limited to the left, right, up, and down directions of the body, but may be set freely according to needs.

In some exemplary embodiments, in a tracking mode, movement trajectories of the mobile platform that can bypass the obstacle may be determined based on the tracking instruction and information of the obstacle when the distance from the obstacle is less than the predetermined distance, and then the obstacle-avoiding auxiliary instruction may be generated based on the trajectories and the tracking instruction to enable the mobile platform to bypass the obstacle under the action of the obstacle-avoiding auxiliary instruction, thereby achieving auxiliary obstacle-avoidance in the tracking mode, and improving the safety of the mobile platform during the movement of the mobile platform as well as user experience.

In contrast to the process of generating an obstacle-avoiding auxiliary instruction as shown in FIG. 6, other embodiments of the present disclosure provide a process of generating an obstacle-avoiding auxiliary instruction, which may include: generating one or more of the obstacle-avoiding auxiliary instructions based on the tracking instruction when a distance from an obstacle is less than a predetermined distance.

For example, as mentioned above, the mobile platform may obtain the current position of the mobile platform and the current position of the target object, and run a preset target tracking algorithm according to the current position of the mobile platform and the current position of the target object to obtain a tracking instruction that controls the mobile platform to follow the movement of the target object. After obtaining the tracking instruction, the mobile platform may generate one or more obstacle-avoiding auxiliary instructions according to the tracking. The value or magnitude and/or direction of the obstacle-avoiding auxiliary instruction may be determined according to the tracking instruction.

As shown in FIG. 9, the mobile platform may receive a tracking instruction T, and determine obstacle-avoiding auxiliary instructions A1, A2, A3, and A4 according to the tracking instruction T. In some cases, the directions of the obstacle-avoiding auxiliary instructions A1, A2, A3, and A4 may be perpendicular to the direction of the tracking instruction, i.e., the directions of actions of the obstacle-avoiding auxiliary instructions A1, A2, A3, and A4 to the mobile platform may be perpendicular to the direction of action of the tracking instruction on the mobile platform. It is understandable that included angles between the directions of the obstacle-avoiding auxiliary instructions A1, A2, A3, and A4 and the direction of the tracking instruction may be other angles, and is not specifically limited herein. In some cases, the value or magnitude of each of the obstacle-avoiding auxiliary instructions A1, A2, A3, and A4 may be in a preset proportional relationship with the value or magnitude of the tracking instruction. When the value of tracking instruction increases, the obstacle-avoiding auxiliary instructions A1, A2, and A3 may increase accordingly, and when the tracking instruction decrease, the obstacle-avoiding auxiliary instructions A1, A2, and A3 may decrease accordingly.

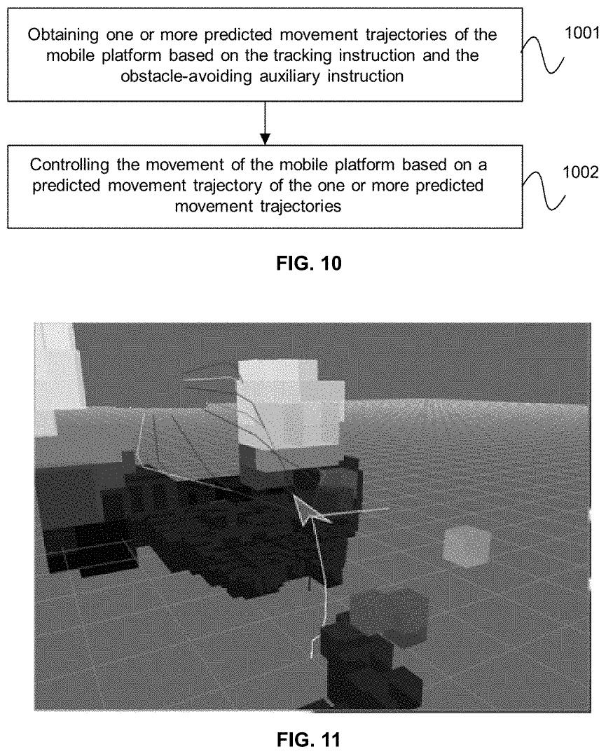

FIG. 10 is a flowchart of a process for performing step 103 according to some exemplary embodiments of the present disclosure. In the embodiments shown in FIG. 10, in step 101, when it is detected that the distance between the mobile platform and the obstacle is within a predetermined distance range, one or more obstacle-avoiding auxiliary instructions may be generated. The process of generating the obstacle-avoiding auxiliary instruction may be similar to the method in the above description, and will not be discussed herein. As shown in FIG. 10, based on the embodiments shown in FIG. 1, step 103 may further include the following steps.

Step 1001. Obtaining one or more predicted movement trajectories of the mobile platform based on the tracking instruction and the obstacle-avoiding auxiliary instruction.

For example, after the tracking instruction is obtained, the moving state of the mobile platform corresponding to the tracking instruction may be used as an initial state of a trajectory prediction model according to a preset trajectory prediction model. By adopting the tracking instruction and the obstacle-avoiding auxiliary instruction as input into the trajectory prediction model, a movement trajectory corresponding to each obstacle-avoiding auxiliary instruction may be predicted and obtained. In other words, one or more movement trajectories of the mobile platform may be predicted.

In some exemplary embodiments, if an obstacle-avoiding auxiliary instruction (hereinafter referred to as a current obstacle-avoiding auxiliary instruction) is used in the current movement process of the mobile platform, the moving state of the mobile platform corresponding to the tracking instruction may be used as the initial state of the trajectory prediction model. By using the tracking instruction and the current obstacle-avoiding auxiliary instruction as input into the trajectory prediction model, the current movement trajectory of the mobile platform may be obtained based on the prediction of the trajectory prediction model. Or, when an obstacle-avoiding auxiliary instruction is not used in the current movement of the mobile platform, by using the moving state of the mobile platform corresponding to the tracking instruction as the initial state of the trajectory prediction model, and using the tracking instruction as input into the trajectory prediction model, the current movement trajectory of the mobile platform may be obtained based on the prediction of the trajectory prediction model.

Step 1002. Controlling the movement of the mobile platform based on a predicted movement trajectory of the one or more predicted movement trajectories.

There may be many ways for the mobile platform to determine a target movement trajectory from the candidate movement trajectories obtained by prediction. For example, based on the map information of the current environment stored by the mobile platform, the mobile platform may determine the target movement trajectory from one or more candidate movement trajectories of the mobile platform obtained by prediction according to at least one of the following selection conditions, and control the movement of the mobile platform according to the target movement trajectory.

In a possible implementation manner, one or more movement trajectories obtained by prediction may be displayed first. FIG. 11 is a schematic diagram of a plurality of movement trajectories according to some exemplary embodiments of the present disclosure, as shown in FIG. 11. In this implementation manner, a user-operable interface may be provided, so that the user may select the movement trajectory of the mobile platform from a plurality of displayed movement trajectories. When the user's selection operation is detected, the movement of the mobile platform may be controlled based on the movement trajectory selected by the user.

In another possible implementation manner, based on a preset track selection strategy, a movement trajectory may be selected from the obtained one or more movement trajectories, so that the mobile platform may move along the movement trajectory. For example, in consideration of an energy factor and a moving distance factor, the movement trajectory having a movable distance greater than the first preset threshold and the minimum energy consumption (including the energy consumed by the obstacle-avoiding auxiliary instruction and/or the energy consumed by the movement of the mobile platform) may be selected, and the mobile platform may be controlled to move along the movement trajectory. In some exemplary embodiments, the movement trajectory having energy consumption less than the second preset threshold and the maximum movable distance may be selected. In some exemplary embodiments, firstly the movement trajectory having a movable distance greater than the first preset threshold and/or having energy consumption less than the second preset threshold may be obtained from one or more movement trajectories obtained by the prediction, and then based on the movement trajectory in the obtained movement trajectories having a movable distance greater than or equal to the movable distance of the current movement trajectory of the mobile platform, the movement of the mobile platform may be controlled. For example, in consideration of optimum configuration of energy, the movement trajectory having a movable distance greater than or equal to the current movement trajectory of the mobile platform and the minimum energy consumption may be selected for display, and the movement of the mobile platform may be controlled based on the movement trajectory. In some exemplary embodiments, in consideration of interaction, the movement trajectory in the movement trajectories obtained by prediction having a movable distance greater than or equal to the movable distance of the current movement trajectory of the mobile platform may be displayed for example, on a screen or displayer of a remote controller of the mobile platform, and the movement of the mobile platform may be controlled according to the movement trajectory selected by the user.

Further, if the movable distances of the movement trajectories obtained having a movable distance greater than the first preset threshold and/or having energy consumption less than the second preset threshold are all less than the movable distance of the current movement trajectory of the mobile platform, the mobile platform may be controlled to perform a braking operation to avoid a collision.

Further, if the movable distances of the movement trajectories obtained having a movable distance greater than the first preset threshold and/or having energy consumption less than the second preset threshold are all less than the movable distance of the current movement trajectory of the mobile platform, after the mobile platform may be controlled to perform a braking operation, the mobile platform may perform path planning based on the map information of the current environment to obtain the movement trajectory. For example, the mobile platform may use a rapidly exploring random tree (RRT) path planning algorithm to search in the map of the current environment for a path close to the current movement trajectory, and smooth the path to obtain a movement trajectory.

In some exemplary embodiments, one or more movement trajectories of the mobile platform are obtained by prediction based on the one or more obstacle-avoiding auxiliary instructions generated and the tracking instruction, and the movement of the mobile platform may be controlled based on one of the one or more movement trajectories, thereby improving flexibility of obstacle-avoidance by the mobile platform in the tracking mode.

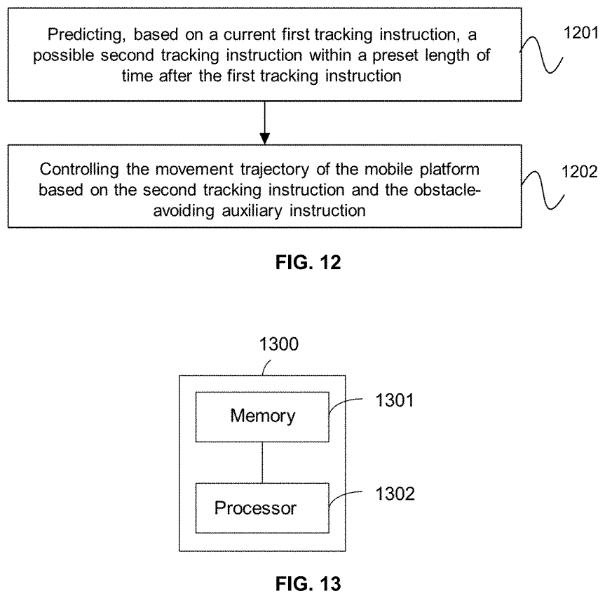

FIG. 12 is a flowchart of a process for performing step 103 according to some exemplary embodiments of the present disclosure. In the embodiments shown in FIG. 12, as shown in FIG. 12, on the basis of the embodiments shown in FIG. 1 or FIG. 10, step 103 may further include the following steps.

Step 1201. Predicting, based on a current first tracking instruction, a possible second tracking instruction within a preset length of time after the first tracking instruction.

In some exemplary embodiments, the tracking instruction may include the current first tracking instruction and the second tracking instruction obtained by prediction based on the first tracking instruction. The second tracking instruction may be obtained by inputting the first tracking instruction into a preset instruction prediction model and outputting by the instruction prediction model. The preset time length after the first tracking instruction may refer to a certain time window in the future as described above, and the instruction prediction model may be established with any method provided by the prior art, which is not specifically limited in these embodiments.

Step 1202. Controlling the movement trajectory of the mobile platform based on the second tracking instruction and the obstacle-avoiding auxiliary instruction.

For example, after the second tracking instruction is obtained, according to the preset trajectory prediction model, the movement trajectory corresponding to each obstacle-avoiding auxiliary instruction may be obtained by a prediction by taking the moving state of the mobile platform corresponding to the first tracking instruction as the initial state of the trajectory prediction model, and taking the second tracking instruction and the obstacle-avoiding auxiliary instruction as input into the track prediction model. That is, the above content may be exemplarily expressed as predicting one or more movement trajectories of the mobile platform based on the first tracking instruction, the second tracking instruction, and the obstacle-avoiding auxiliary instruction.

In some exemplary embodiments, if the current movement process of the mobile platform includes an obstacle-avoiding auxiliary instruction (hereinafter referred to as a current obstacle-avoiding auxiliary instruction), the current movement trajectory of the mobile platform may be obtained based on the prediction of the trajectory prediction model by taking the moving state of the mobile platform corresponding to the first tracking instruction as the initial state of the trajectory prediction model, and taking the second tracking instruction and the current obstacle-avoiding auxiliary instruction as input into the trajectory prediction model. In some exemplary embodiments, when an obstacle-avoiding auxiliary instruction is not used in the current movement process of the mobile platform, the current movement trajectory of the mobile platform may be obtained based on a prediction by the trajectory prediction model by taking the moving state of the mobile platform corresponding to the first tracking instruction as the initial state of the trajectory prediction model, and taking the second tracking instruction as input into the trajectory prediction model.

There may be many ways for the mobile platform to determine the target movement trajectory from the candidate movement trajectories obtained by prediction. For example, based on the map information of the current environment stored by the mobile platform, the mobile platform may determine the target movement trajectory from one or more candidate movement trajectories of the mobile platform obtained by prediction according to at least one of the following selection conditions, and control the movement of the mobile platform according to the target movement trajectory.

In a possible implementation manner, one or more movement trajectories obtained by prediction may be displayed first. Referring to FIG. 11 again, FIG. 11 is a schematic diagram of a plurality of movement trajectories according to some exemplary embodiments of the present disclosure. In this implementation manner, a user-operable interface may be provided, so that the user may select a movement trajectory of the mobile platform from a plurality of displayed movement trajectories. When the user's selection operation is detected, the movement of the mobile platform may be controlled based on the movement trajectory selected by the user.

In another possible implementation manner, a movement trajectory may be selected from the one or more movement trajectories obtained based on the preset trajectory selection strategy as described above, so that the mobile platform may move along the selected movement trajectory. Please refer to the previous part for specific explanations and principles, which will not be discussed herein. In some exemplary embodiments, a possible second tracking instruction within a preset length of time after the first tracking instruction may be predicted based on the first tracking instruction, one or more movement trajectories of the mobile platform may be obtained by prediction according to the first tracking instruction, the second tracking instruction, and the obstacle-avoiding auxiliary instruction, and the movement of the mobile platform may be controlled according to one of the one or more movement trajectories obtained by prediction. As a result, the generated movement trajectory may be more reliable, avoiding that the currently generated movement trajectory will lose obstacle-avoiding function due to other tracking instructions within the preset length of time after the first tracking instruction. In addition, in some exemplary embodiments, since one or more obstacle-avoiding auxiliary instruction are firstly obtained based on the tracking instruction and then the movement trajectory of the mobile platform is obtained by prediction based on the obtained one or more obstacle-avoiding auxiliary instructions and the tracking instruction, the generation of the obstacle-avoiding auxiliary instructions may be more flexible in some exemplary embodiments.

Embodiments of the present disclosure may provide a mobile device. FIG. 13 is a structural diagram of a mobile device according to some exemplary embodiments of the present disclosure. As shown in FIG. 13, a mobile device 1300 may include a memory 1301 for storing program codes, and a processor 1302 for invoking the program codes. When the program codes are executed, the processor 1302 is configured to perform the following operations: in a tracking mode, detecting a distance between the mobile platform and an obstacle; generating an obstacle-avoiding auxiliary instruction when the distance from the obstacle is less than a predetermined distance; and controlling a movement trajectory of the mobile platform based on a tracking instruction and the obstacle-avoiding auxiliary instruction, wherein the tracking instruction is used for instructing the mobile platform to track a target object.

In some exemplary embodiments, the obstacle-avoiding auxiliary instruction generated by the processor 1302 may be configured to increase a velocity component of the mobile platform in a first direction, wherein the first direction may be perpendicular to the direction of the mobile platform facing towards the obstacle.

In some exemplary embodiments, the obstacle-avoiding auxiliary instruction generated by the processor 1302 may be configured to reduce or offset a velocity component of the mobile platform in a direction facing towards the obstacle and caused by the tracking instruction.

In some exemplary embodiments, the direction in which the obstacle-avoiding auxiliary instruction generated by the processor 1302 acts on the mobile platform may be perpendicular to the direction in which the tracking instruction acts on the mobile platform.

In some exemplary embodiments, when generating the obstacle-avoiding auxiliary instruction, the processor 1302 may perform the following operations: determining the movement trajectory of the mobile platform that can bypass the obstacle based on the tracking instruction and the obstacle when the distance from the obstacle is less than the predetermined distance; and generating the obstacle-avoiding auxiliary instruction based on the movement trajectory and the tracking instruction.

In some exemplary embodiments, when invoking the program codes, the processor 1302 may perform the following operation: transmitting the current movement trajectory of the mobile platform and/or the movement trajectory of the mobile platform that can bypass the obstacle to a ground station for display.

In some exemplary embodiments, when generating the obstacle-avoiding auxiliary instruction, the processor 1302 may further perform the following operation: generating one said obstacle-avoiding auxiliary instruction or more based on the tracking instruction when the distance from the obstacle is less than the predetermined distance.

In some exemplary embodiments, when controlling the movement trajectory of the mobile platform based on the tracking instruction and the obstacle-avoiding auxiliary instruction, the processor 1302 may perform the following operations: predicting one or more movement trajectories of the mobile platform based on the tracking instruction and the obstacle-avoiding auxiliary instruction; and controlling movement of the mobile platform based on one of the one or more movement trajectories.

In some exemplary embodiments, when invoking the program codes, the processor 1302 may further perform the following operation: transmitting the one or more movement trajectories to a ground station for display.

In some exemplary embodiments, when invoking the program codes, the processor 1302 may further perform the following operations: obtaining the user's selection operation on the one or more movement trajectories; and controlling the movement of the mobile platform based on the movement trajectories selected by the user.

In some exemplary embodiments, when controlling the movement of the mobile platform based on one of the one or more movement trajectories, the processor 1302 may perform the following operation: controlling the movement of the mobile platform based on a movement trajectory in the one or more movement trajectories having a movable distance greater than a first preset threshold and the minimum energy consumption.

In some exemplary embodiments, when controlling the movement of the mobile platform based on one of the one or more movement trajectories, the processor 1302 may perform the following operation: controlling the movement of the mobile platform based on a movement trajectory of the one or more movement trajectories having energy consumption less than a second preset threshold and the maximum movable distance.

In some exemplary embodiments, when controlling the movement of the mobile platform based on one of the one or more movement trajectories, the processor 1302 may perform the following operations: obtaining, from the one or more movement trajectories, a movement trajectory having a movable distance greater than a first preset threshold and/or energy consumption less than a second preset threshold; and controlling the movement of the mobile platform based on a movement trajectory in the movement trajectories having a movable distance greater than or equal to a movable distance of a current movement trajectory of the mobile platform.

In some exemplary embodiments, when invoking the program codes, the processor 1302 may further perform the following operation: transmitting a movement trajectory in the movement trajectories having a movable distance greater than or equal to a movable distance of a current movement trajectory of the mobile platform to a ground station for display.

In some exemplary embodiments, when controlling the movement of the mobile platform based on a movement trajectory in the movement trajectories having a movable distance greater than or equal to a movable distance of a current movement trajectory of the mobile platform, the processor 1302 may perform the following operation: controlling the movement of the mobile platform based on a movement trajectory in the movement trajectories having a movable distance greater than or equal to a movable distance of a current movement trajectory of the mobile platform and the minimum energy consumption.

In some exemplary embodiments, when invoking the program codes, the processor 1302 may further perform the following operation: transmitting a movement trajectory in the movement trajectories having a movable distance greater than or equal to a movable distance of a current movement trajectory of the mobile platform and the minimum energy consumption to a ground station for display.

In some exemplary embodiments, when invoking the program codes, the processor 1302 may further perform the following operation: controlling the mobile platform to perform a braking operation when the movable distances of the movement trajectories are all less than the movable distance of the current movement trajectory of the mobile platform.

In some exemplary embodiments, after controlling the mobile platform to perform a braking operation, the processor 1302 may further perform the following operation: performing path planning based on map information of a current environment to obtain the movement trajectories.

The mobile device provided In some exemplary embodiments can execute the auxiliary moving method of the mobile platform provided in the above embodiments, the execution mode, and beneficial effects are similar, and will not be discussed herein.

Embodiments of the present disclosure may further provide a mobile platform, including: a body; a power system installed on the body and configured to supply power to the mobile platform; and a mobile device according to the above embodiments.

In some exemplary embodiments, the mobile platform may further include a sensor installed on the body and configured to detect and obtain map information of the environment where the mobile platform is located.

In some exemplary embodiments, the sensor may include a vision sensor and/or a distance sensor.

In some exemplary embodiments, the mobile platform may further include: a communication device installed on the body and configured for information interaction with a ground station.

In some exemplary embodiments, the mobile platform may include at least one of drones and automobiles.

The execution mode and beneficial effects of the mobile platform provided in some exemplary embodiments are similar to those of the mobile device according to the above embodiments, and will not be discussed herein.

In several embodiments according to the present disclosure, it should be understood that the disclosed device and method may be implemented in other ways. For example, the device embodiments described above are only illustrative, division of the units is only a logical function division, and there may be other divisions in actual implementation. For example, a plurality of units or components may be combined or integrated into another system, or some features may be ignored or not implemented. In addition, the displayed or discussed mutual coupling or direct coupling or communicative connection may be indirect coupling or communicative connection through some interfaces, devices or units, and may be in electrical, mechanical or other forms.

The units described as separate components may or may not be physically separated, and the components displayed as units may or may not be physical units. In other words, they may be positioned in one place, or they may be distributed on a plurality of network units. Some or all of the units may be selected according to actual needs to achieve the objectives of the solutions of the embodiments.

In addition, the functional units in various embodiments of the present disclosure may be integrated into one processing unit, or each of the units may exist alone physically, or two or more of the units may be integrated into one unit. The above-integrated unit may be implemented in the form of hardware, or in the form of hardware plus software functional units.

The above-integrated unit implemented in the form of software functional units may be stored in a computer-readable storage medium. The above software functional units, which are stored in a storage medium, include several instructions to enable a computer device (which may be a personal computer, a server, a network device, and the like) or a processor to execute part of the steps of the method described in various embodiments of the present disclosure. The storage medium covers various media that can store program codes such as a U disk, a mobile hard disk, a read-only memory (ROM), a random-access memory (RAM), a magnetic disk, and an optical disk.

Those skilled in the art can clearly understand that, for the convenience and conciseness of the description, division of the above functional modules is merely taken as an example. In practical applications, the functions may be allocated by different functional modules as required. That is, the internal structure of the device is divided into different functional modules to complete all or part of the functions described above. Please refer to corresponding process in the above method embodiments for the specific working process of the device described above, which will not be discussed herein.

Finally, it should be noted that the above embodiments are only used to illustrate technical solutions of the present disclosure rather than limit them. Although the present disclosure has been described in detail with reference to the above embodiments, those skilled in the art should understand that modifications to the technical solutions of the embodiments or equivalent substitutions of part or all of the technical features therein may be made, and these modifications or substitutions do not cause essence of the corresponding technical solutions to deviate from the scope of the technical solutions of the embodiments of the present disclosure.

What is claimed is:

1. An auxiliary moving method of a mobile platform, comprising:
generating, by a mobile platform in a tracking mode, an obstacle-avoiding auxiliary instruction when the mobile platform is tracking a target object and a distance between the mobile platform and an obstacle is less than a predetermined distance; and
controlling a movement trajectory of the mobile platform based on a tracking instruction and the obstacle-avoiding auxiliary instruction.

2. The auxiliary moving method according to claim 1, wherein the obstacle-avoiding auxiliary instruction is configured to increase a velocity component of the mobile platform in a first direction, and the first direction is perpendicular to the second direction in which the mobile platform points to the obstacle.

3. The auxiliary moving method according to claim 2, wherein the obstacle-avoiding auxiliary instruction is configured to reduce or offset a velocity component of the mobile platform that is caused by the tracking instruction in the second direction.

4. The auxiliary moving method according to claim 1, wherein a direction in which the obstacle-avoiding auxiliary instruction acts on the mobile platform is perpendicular to a direction in which the tracking instruction acts on the mobile platform.

5. The auxiliary moving method according to claim 1, wherein the generating of the obstacle-avoiding auxiliary instruction further includes:
when the distance between the mobile platform and the obstacle is less than the predetermined distance, determining the movement trajectory of the mobile platform that bypasses the obstacle based on the tracking instruction and information of the obstacle; and
generating the obstacle-avoiding auxiliary instruction based on the movement trajectory and the tracking instruction.

6. The auxiliary moving method according to claim 5, further comprising:
displaying at least one of
a current movement trajectory of the mobile platform, or
the movement trajectory of the mobile platform that bypasses the obstacle.

7. The auxiliary moving method according to claim 1, wherein the generating of the obstacle-avoiding auxiliary instruction further includes:
generating one or more obstacle-avoiding auxiliary instruction based on the tracking instruction.

8. The auxiliary moving method according to claim 1, wherein the controlling of the movement trajectory of the mobile platform further includes:
obtaining one or more predicted movement trajectories of the mobile platform based on the tracking instruction and the obstacle-avoiding auxiliary instruction; and
controlling the movement of the mobile platform based on a predicted movement trajectory of the one or more predicted movement trajectories.

9. The auxiliary moving method according to claim 8, further comprising:
displaying the one or more predicted movement trajectories.

10. The auxiliary moving method according to claim 8, further comprising:
obtaining a user's selection operation on the one or more predicted movement trajectories; and
controlling the movement of the mobile platform based on a selected movement trajectory selected by the user.

11. The auxiliary moving method according to claim 8, wherein the controlling of the movement of the mobile platform further includes:
controlling the movement of the mobile platform based on a predicted movement trajectory of the one or more predicted movement trajectories that has
a movable distance greater than a first preset threshold, and
minimum energy consumption.

12. The auxiliary moving method according to claim 8, wherein the controlling of the movement of the mobile platform further includes:
controlling the movement of the mobile platform based on a predicted movement trajectory of the one or more predicted movement trajectories that has
energy consumption less than a second preset threshold, and
a maximum movable distance.

13. The auxiliary moving method according to claim 8, wherein the controlling of the movement of the mobile platform further includes:
obtaining, from the one or more predicted movement trajectories, one or more candidate movement trajectories, each having at least one of
a movable distance greater than a first preset threshold, or
energy consumption less than a second preset threshold; and
controlling the movement of the mobile platform based on a candidate movement trajectory of the one or more candidate movement trajectories that has a movable distance greater than or equal to a movable distance of a current movement trajectory of the mobile platform.

14. The auxiliary moving method according to claim 13, further comprising:
displaying the candidate movement trajectory having a movable distance greater than or equal to the movable distance of the current movement trajectory of the mobile platform.

15. The auxiliary moving method according to claim 13, wherein the controlling of the movement of the mobile platform based on the candidate movement trajectory further includes:
controlling the movement of the mobile platform based on a candidate movement trajectory having
a movable distance greater than or equal to a movable distance of a current movement trajectory of the mobile platform, and
minimum energy consumption.

16. The auxiliary moving method according to claim 15, further comprising:
displaying the candidate movement trajectory having
a movable distance greater than or equal to the movable distance of the current movement trajectory of the mobile platform, and
the minimum energy consumption.

17. The auxiliary moving method according to claim 13, further comprising:
determining that the movable distance of each of the one or more candidate movement trajectories is less than the movable distance of the current movement trajectory of the mobile platform; and
controlling the mobile platform to perform a braking operation.

18. The auxiliary moving method according to claim 17, further comprising:
after the controlling of the mobile platform to perform the braking operation, performing path planning based on map information of a current environment of the mobile platform to obtain a movement trajectory.

19. A mobile device, comprising:
a storage medium storing program codes for performing auxiliary moving over a mobile platform; and
a processor to execute the program codes to:
generating, by the mobile platform in a tracking mode, an obstacle-avoiding auxiliary instruction when the mobile platform is tracking a target object and a distance between the mobile platform and an obstacle is less than a predetermined distance; and
controlling a movement trajectory of the mobile platform based on a tracking instruction and the obstacle-avoiding auxiliary instruction.

20. The mobile device according to claim 19, wherein a direction in which the obstacle-avoiding auxiliary instruction acts on the mobile platform is perpendicular to a direction in which the tracking instruction acts on the mobile platform.
